(19) United States
(12) Patent Application Publication
(10) Pub. No.: US 2023/0011333 A1
(43) Pub. Date: Jan. 12, 2023

(54) FACILITY USE MANAGEMENT SYSTEM AND FACILITY USE MANAGEMENT METHOD

(71) Applicant: TOYOTA JIDOSHA KABUSHIKI KAISHA, Toyota-shi (JP)

(72) Inventors: Daiki Kaneichi, Tokyo-to (JP); Yohei Saiki, Nagoya-shi (JP); Minoru Nakadori, Tokyo-to (JP)

(73) Assignee: TOYOTA JIDOSHA KABUSHIKI KAISHA, Toyota-shi (JP)

(21) Appl. No.: 17/858,276

(22) Filed: Jul. 6, 2022

(30) Foreign Application Priority Data
Jul. 12, 2021 (JP) 2021-114960

(51) Int. Cl. G06Q 10/02; G08G 1/14

(52) U.S. Cl. CPC G06Q 10/02; G08G 1/149; G08G 1/148

(57) ABSTRACT

Recommendation data that matches a preference of a user and includes data on a facility available for the user is generated based on various data. The various data include registration data on the user, hobby data on the user, registration data on the various facilities, and use situation data on the various facilities. The recommendation data is transmitted to the user terminal. After transmission of the recommendation data, it is determined whether the reservation request data has been received from the user terminal or not. The reservation request data includes data on a requested facility wished by the user, and data on an available time slot of the requested facility. When it is determined that the reservation request data has been received, a reservation of the requested facility covering the available time slot is made based on the reservation request data.

The present disclosure claims priority under 35 U.S.C. § 119 to Japanese Patent Application No. 2021-114960, filed on Jul. 12, 2021, the contents of which application are incorporated herein by reference in their entirety.

### TECHNICAL FIELD

The present disclosure relates to a system and method for managing use of various facilities by a user.

### BACKGROUND

JP 2004-102723 A discloses a system for making a reservation of a facility. The conventional system includes a server, and a user terminal. Upon receipt of a reservation request through the user terminal, the server searches a database that stores congestion information on the facility, based on a reservation condition included in the reservation request. The reservation condition includes information about a facility category, a time slot, and the number of people. When a facility satisfying the reservation condition is extracted, the server creates a reservation plan, and transmits the plan to the user terminal. When multiple facilities satisfying the reservation condition are extracted, the server creates alternative plans that combine uses of these facilities and transmit the plan to the user terminal.

From the standpoint of the user operating the user terminal, the system described above is discussed. The user is assumed to input a reservation condition into the user terminal, based on an intention of using a facility in a specific category. However, there is also a user excursively wishing to use a facility belonging to a certain category. Such a user is expected to use the facility when the available time period of the facility in the category matching their preference conforms to their schedule.

Unfortunately, the system described above does not have a configuration for notifying the user whether the facility in the category matching the preference of the user is available or not. Accordingly, to use a reservation service provided by the system described above, the user is required to check by themself what category of facilities reside. This requires the user to take some efforts, but does not possibly lead to use of the facility. There is thus a room for improvement in view of providing information useful for the user excursively wishing use of the facility belonging to a certain category and of facilitating use of the facility.

It is an object of the present disclosure to provide a technology capable of providing information useful for the user excursively wishing to use a facility belonging to a certain category and of facilitating use of the facility by the user.

### SUMMARY

A first aspect of the present disclosure is a facility use management system that manages use of various facilities by a user, and has the following features.

The facility use management system includes a management server, and a user terminal.

The management server includes a storage device in which various data is stored, and a data processing device. The various data include registration data on the user, hobby data on the user, registration data on the various facilities, and use situation data on the various facilities.

The user terminal is operated by the user and is configured to be communicate with the management server.

The data processing device of the management server is configured to:

generates, based on the various data, recommendation data including data on facilities that match a preference of the user and are available to the user,

transmits the recommendation data to the user terminal, and

determines whether reservation request data is received from the user terminal or not after transmission of the recommendation data. The reservation request data includes data on a requested facility wished by the user, and data on an available time slot of the requested facility.

When it is determined that the reservation request data is received from the user terminal, the data processing device of the management server makes a reservation of the requested facility covering the available time slot, based on the reservation request data.

A second aspect of the present disclosure further has the following features besides those of the first aspect.

The facility use management system further includes a parking lot, and a plurality of mobiles.

The parking lot includes a communication device that communicates with the management server and a data processing device.

Each of the mobiles includes a communication device that communicates with the management server and the parking lot, a drive device, and a control device that controls the drive device.

Upon receipt of the reservation request data from the user terminal, the data processing device of the management server determines whether the reservation request data includes transportation request data or not. The transportation request data includes data on a pickup point wished by the user, and a pickup time slot wished by the user.

The data processing device of the management server is configured to:

when it is determined that the reservation request data includes the transportation request data, generate a transportation arrangement instruction for providing the user with transportation from the pickup point to the requested facility, based on the transportation request data; and transmit the transportation arrangement instruction to the parking lot.

The data processing device of the parking lot is configured to:

upon receipt of the transportation arrangement instruction, select a mobile for transportation of the user from among the mobiles, based on the transportation arrangement instruction; and

transmit a transportation execution instruction to the selected mobile.

The control device of the selected mobile is configured to perform, upon receipt of the transportation execution instruction, automated driving control from the parking lot to the pickup point, and automated driving control from the pickup point to the requested facility, based on the transportation execution instruction.

A third aspect of the present disclosure further has the following features besides those of the first aspect.

The facility use management system further includes a material center and a plurality of delivery robots.

The material center includes a communication device that communicates with the management server and a data processing device.

Each of the delivery robots includes a communication device that communicates with the management server and the material center, a drive device, and a control device that controls the drive device.

The data processing device of the management server is configured to determine, upon receipt of the reservation request data from the user terminal whether the reservation request data includes delivery request data or not. The delivery request data includes data on a requested material wished by the user, data on a delivery destination of the requested material, and data on a delivery time slot for the requested material.

The data processing device of the management server is configured to:

when it is determined that the reservation request data includes the delivery request data, generate a delivery arrangement instruction for delivering the requested material from the material center to the delivery destination, based on the delivery request data; and

transmit the delivery arrangement instruction to the material center.

The data processing device of the material center is configured to:

upon receipt of the delivery arrangement instruction, select a delivery robot for delivering the requested material, from among the delivery robots, based on the delivery arrangement instruction; and

transmit a delivery execution instruction to the selected delivery robot.

The control device of the selected delivery robot is configured to perform, upon receipt of the delivery execution instruction, automated driving control from the material center to the delivery destination, based on the delivery execution instruction.

A fourth aspect of the present disclosure is a facility use management method to manage use of various facilities by a user through a management server, and has the following features.

The facility use management method includes the steps of:

generating recommendation data including data on a facility that matches a preference of the user and is available for the user, based on various data stored in a storage device, the various data including registration data on the user, hobby data on the user, registration data on the various facilities, and use situation data on the various facilities;

transmitting the recommendation data to the user terminal;

determining whether reservation request data is received from the user terminal or not after transmission of the recommendation data, the reservation request data including data on a requested facility wished by the user, and an available time slot of the requested facility; and

making a reservation of the requested facility covering the available time slot, based on the reservation request data, when it is determined that the reservation request data is from the user terminal.

According to the first or fourth aspect, the recommendation data is transmitted to the user terminal. The recommendation data includes the data on the facility that matches the preference of the user and is available for the user. That is, the recommendation data can be regarded as information useful for the user excursively wishing to use a facility belonging to a certain category. According to the first or fourth aspect, when the reservation request data is transmitted, from the user terminal, as a response to provision of the recommendation data, the requested facility wished by the user is automatically reserved to cover the available time slot. Consequently, use of the facility by the user excursively wishing to use a facility belonging to a certain category is facilitated.

According to the second aspect, when the reservation request data includes the transportation request data, transportation means to the requested facility is automatically arranged. Consequently, preparation, arrangement and the like of the transportation means are prevented from serving as an impediment against use of the facility. This is expected to lead to further enhancement of use of the facility by the user.

According to the third aspect, when the reservation request data includes the delivery request data, the requested material is automatically delivered to the delivery destination. Consequently, preparation, arrangement and the like of the material are prevented from serving as an impediment against use of the facility. This is expected to lead to further enhancement of use of the facility by the user.

### BRIEF DESCRIPTION OF DRAWINGS

FIG. 1 is a diagram illustrating an overall configuration example of a management system according to an embodiment;

FIG. 2 is a diagram illustrating an example of various data exchanged between configuration elements of the management system shown in FIG. 1;

FIG. 3 is a diagram illustrating a configuration example of data about a leisure facility;

FIG. 4 is a diagram illustrating a configuration example of data about a user;

FIG. 5 is a diagram illustrating a configuration example of data about a parking lot;

FIG. 6 is a diagram illustrating a configuration example of data about a material center;

FIG. 7 is a diagram illustrating a configuration example of the reservation request data;

FIG. 8 is a flowchart illustrating an example of processing performed by the management server;

FIG. 9 is a flowchart illustrating another example of processing performed by the management server;

FIG. 10 is a flowchart illustrating an example of processing performed by the leisure facility;

FIG. 11 is a flowchart illustrating an example of processing performed by the parking lot;

FIG. 12 is a flowchart illustrating an example of processing performed by a mobile in charge for a transportation of the user;

FIG. 13 is a flowchart illustrating an example of processing performed by the mobile in charge for the transportation of the user;

FIG. 14 is a flowchart illustrating an example of processing performed by the material center; and

FIG. 15 is a flowchart illustrating an example of processing performed by the selected robot.

### DESCRIPTION OF EMBODIMENT

Hereinafter, referring to the drawings, a facility use management system (hereinafter, also simply called “management system”) and a facility use management method according to embodiments of the present disclosure are described. Note that the facility use management method according to the embodiment is achieved by computer processing executed by the management system according to the embodiment. In the individual drawings, the same or equivalent parts are assigned the same symbols, and the description thereof is simplified or omitted.

1. Overall Configuration of System

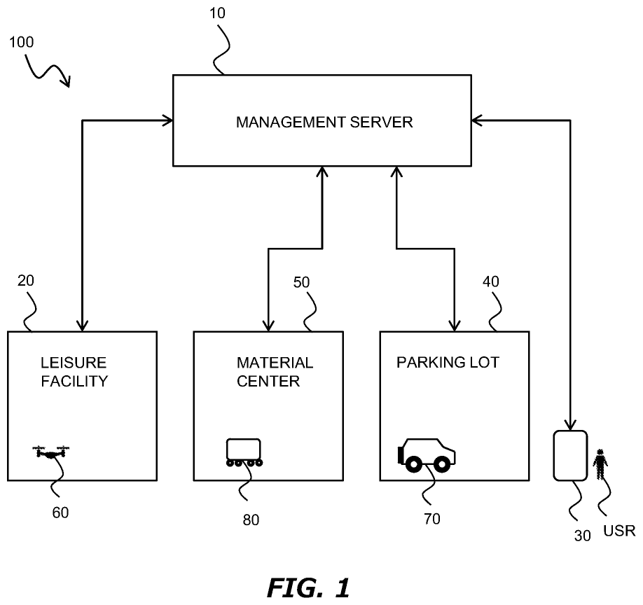

FIG. 1 illustrates an overall configuration example of a management system according to an embodiment. In the example illustrated in FIG. 1, the management system 100 includes a management server 10, a leisure facility 20, a user terminal 30, a parking lot 40, and a material center 50. The management server 10 communicates with configuration elements, such as the leisure facility 20 and the user terminal 30, via a network (not illustrated).

The management server 10 is a computer that manages use of the leisure facility 20 by a user USR of the management system 100. The management server 10 performs processing about providing information on the leisure facility 20 for at least one user USR. The management server 10 performs processing about a reservation of the leisure facility 20 by the user USR. The management server 10 further performs processing for reservations (hereinafter, also called “accompanying reservations”) accompanying the reservation. Examples of the accompanying reservations include a reservation of a mobile (e.g., an automobile) 70 by the user USR, and a reservation of various materials.

The leisure facility 20 is any of various facilities that provide the user USR with leisure services. Examples of the leisure facility 20 include tourism facilities, amusement facilities, sport facilities, outdoor recreation facilities, and racecourses. Examples of the tourism facilities include a zoo, and an aquarium. Examples of the amusement facilities include an amusement park, a bowling alley, and a karaoke establishment. Examples of the sport facilities include a workout gym, a futsal court, a golf course, and a ski site. Examples of the outdoor recreation facilities include a park, a camp site, and a barbecue site. Examples of the racecourses include a racing circuit, and a horse-race track.

Examples of the user terminal 30 include a mobile terminal (e.g., a tablet, or a smart phone) owned by the user USR. For example, a predetermined application (specifically, an application for reserving and using the leisure facility 20) is installed in a memory of the user terminal 30. The user USR activates the predetermined application, and performs various procedures about leisure services (a reservation of the leisure facility 20, various types of authentication in the leisure facility 20 and the like). The total number of user terminals 30 are more than the total number of users USR.

The parking lot 40 is a facility that manages automated valet parking (AVP) for a mobile 70. The AVP is to automatically perform an unloading operation of moving the mobile 70 parking in a parking space of the parking lot 40 to a standby space, and a loading operation of moving the mobile stopped in the standby space to the parking space. Typically, the AVP is performed based on communication between a dedicated AVP kit mounted on the mobile 70, and the parking lot 40. According to the AVP, for example, the travel route, the travel time period and the like are adjusted such that the unloading operation of a certain mobile 70 and the loading operation of another mobile 70 would not interfere with each other. The total number of parking lots 40 may be one, or two or more.

The mobile 70 is used by multiple users USR in a shared manner. The mobile 70 performs automated driving (driverless drive) out of the parking lot 40, besides the AVP in the parking lot 40. The automated driving out of the parking lot 40 is performed as part of a transportation service for the user USR. The mobile 70 includes, for example, a communication device, a drive device, and a control device, as components for automated driving. The communication device communicates with the management server 10 and the parking lot 40. The drive device is a device for driving, braking and steering the mobile 70. The control device is a computer for controlling the drive device. Note that the configuration for performing automated driving is publicly known. Accordingly, the description thereof is omitted here.

The material center 50 is a facility that manages various materials used for leisure services. The various materials conform to the content of the leisure services. For example, a case where the leisure service is a sport is assumed. In this case, the various materials include various gears used for the sport, and clothes, such as a uniform. As another example, a case where the leisure service is an outdoor recreation is assumed. In this case, the various materials include various gears used for camp, a set of barbecue equipment. The total number of material centers 50 may be one, or two or more.

The material center 50 is a facility that also manages a delivery robot 80. The delivery robot 80 has a space that can store various materials. The delivery robot 80 performs automated driving out of the material center 50. The automated driving out of the material center 50 is performed as part of a delivery service of various materials. The delivery robot 80 includes, for example, a communication device, a drive device, and a control device, as components for automated driving. The components that are included in the delivery robot 80 and relate to automated driving are basically identical to those included in the mobile 70.

2. Description of Various Data and Data Communication

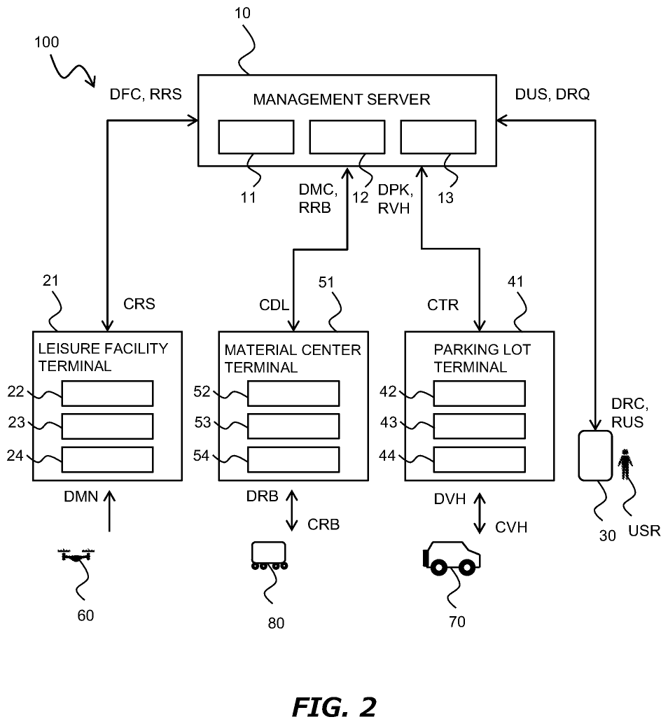

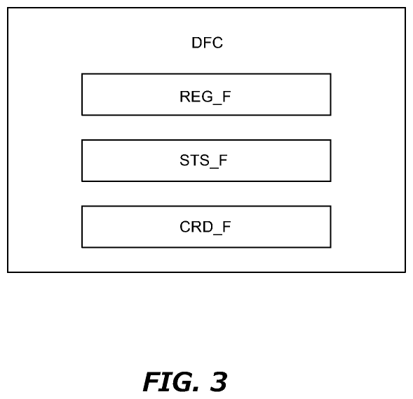

FIG. 2 illustrates an example of various data exchanged between the configuration elements of the management system 100 illustrated in FIG. 1. In the illustration of the various data, the configuration examples of the configuration elements are appropriately described with reference to FIGS. 3 to 7.

In the example illustrated in FIG. 2, the management server 10 includes a database 11, a communication device 12, and a data processing device 13. The database 11 is achieved by a predetermined storage device included in the management server 10. The database 11 may be included in a memory of the data processing device 13. The communication device 12 communicates with the outside of the management server 10. Communication destinations of the communication device 12 include a terminal 21 of the leisure facility 20, the user terminal 30, a terminal 41 of the parking lot 40, and a terminal 51 of the material center 50. The data processing device 13 includes a processor, and a memory.

The processor of the data processing device 13 includes a CPU. Various data required for processing by the processor are stored in the memory of the data processing device 13. Examples of the memory include a volatile memory, a nonvolatile memory, an HDD, and an SSD. Various functions by the data processing device 13 are achieved by the processor executing a computer program. The computer program is stored in the memory of the data processing device 13. The computer program may be recorded in a computer-readable recording medium. The computer program may be provided via a network.

The data processing device 13 is capable of accessing the database 11. The database 11 stores, for example, data DFC about the leisure facility 20, data DUS about the user USR, data DPK about the parking lot 40, and data DMC about the material center 50. Hereinafter, these data are described.

2-1. Various Data Periodically Stored in Database 11

FIG. 3 illustrates a configuration example of the data DFC about the leisure facility 20. In the example illustrated in FIG. 3, the data DFC includes registration data REG_F, use situation data STS_F, and authentication data CRD_F. Note that the data DFC is generated or updated by the terminal 21 in the leisure facility 20 illustrated in FIG. 2. The data DFC is generated and updated by a data processing device 22 included in the terminal 21. Master data on the data DFC is stored in a database 23. Copied data from the data DFC is transmitted to the management server 10 via a communication device 24.

The registration data REG_F illustrated in FIG. 3 includes principal data indicating the content of the leisure services provided by the leisure facility 20; the content includes the place, category and equipment of the leisure facility 20, and the available time period of the equipment. The use situation data STS_F includes data indicating the use situations of the leisure services provided by the leisure facility 20; the situations include the congestion situation and reservation situation of the leisure facility 20. The congestion situation is grasped based on monitoring data DMN obtained by a camera equipped in the leisure facility 20, for example. In a case where the leisure facility 20 is an outdoor recreation facility, the monitoring data DMN may be obtained by a flying object 60, such as a drone.

The authentication data CRD_F is data used for authenticating the terminal 21 when the terminal 21 transmits the data DFC to the management server 10. The authentication data CRD_F is, for example, an authentication code. The authentication data CRD_F may be used when the user USR uses the leisure facility 20.

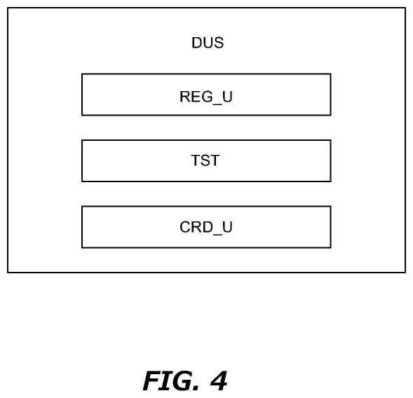

FIG. 4 illustrates a configuration example of the data DUS about the user USR. In the example illustrated in FIG. 4, the data DUS includes registration data REG_U, hobby data TST, and authentication data CRD_U. Data DFU is generated or updated by the user terminal 30 and is transmitted to the management server 10. The data DFU may include data about a future schedule of the user USR who operates the user terminal 30. In the case where the data about the future schedule is included, the data is used to generate recommendation data, which is described later.

The registration data REG_U includes personal data on the user USR, such as the ID, name, age, gender, and home address of the user USR. The registration data REG_U may include data indicating the classification of driver's license owned by the user USR. The hobby data TST is data indicating a hobby of the user USR. The hobby data TST is input into the user terminal 30, separately from the registration data REG_U. The hobby data TST is input by the user USR selecting a hobby category corresponding to the content of the leisure services during execution of a predetermined application by the user terminal 30, for example.

“Play in tourism facilities”, “play in amusement facilities”, “play sport”, “play outdoor”, “enjoy race” and the like are exemplified as hobby categories. These categories correspond to upper categories. Specific leisure facilities, such as tourism facilities, amusement facilities, and sport facilities, correspond to lower categories. The user USR inputs the hobby data TST by selecting the upper or lower category. The user USR changes the hobby data TST as required.

The authentication data CRD_U is data used to authenticate the user terminal 30 when the user terminal 30 transmits the data DUS to the management server 10. The authentication data CRD_U is, for example, an authentication code. The authentication data CRD_U may be used when the user USR uses the leisure facility 20. The authentication data CRD_U in this case may be a QR code (R).

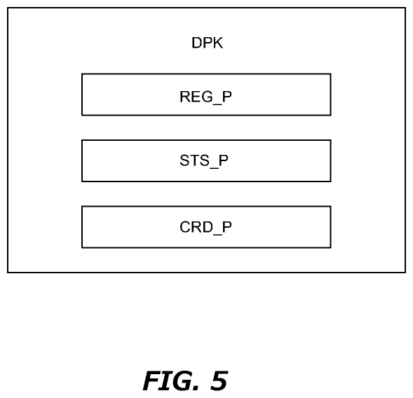

FIG. 5 illustrates a configuration example of the data DPK about the parking lot 40. In the example illustrated in FIG. 5, the data DPK includes registration data REG_P, operation situation data STS_P, and authentication data CRD_P. Note that the data DPK is generated or updated by the terminal 41 in the parking lot 40 illustrated in FIG. 2. The data DPK is generated and updated by a data processing device 42 included in the terminal 41. Master data on the data DPK is stored in a database 43. Copied data from the data DPK is transmitted to the management server 10 via a communication device 44.

The registration data REG_P includes data about facilities of the parking lot 40, such as the place of the parking lot 40, and the position of the standby space included in the parking lot 40. The registration data REG_F includes data about the mobiles 70, such as the total number of mobiles 70 managed by the parking lot 40, the specifications (e.g., the size, capacity, and maximum payload) of each mobile 70. The operation situation data STS_P includes data indicating the operation situations of each mobile 70 managed by the parking lot 40 (e.g., the transportation service in execution, transportation service standby, and AVP in execution). The operation situation data STS_P is generated based on current state report data DVH transmitted from each mobile 70 to the terminal 41.

Here, the current state report data DVH is described. The current state report data DVH includes not only data indicating the operation situations of the mobiles 70 but also data indicating the current positions of the mobiles 70. The current state report data DVH may include data indicating the inner state of the mobile 70, and data indicating the external environment of the mobile 70. Examples of the former include the travel velocity and acceleration of the mobile 70. Examples of the latter include external recognition data recognized by a camera and the like included in the mobile 70. These additional data are used for supporting automated driving of the mobile 70 out of the parking lot 40 as required.

The authentication data CRD_P is data used for authenticating the terminal 41 when the terminal 41 transmits the data DPK to the management server 10. The authentication data CRD_P is, for example, an authentication code.

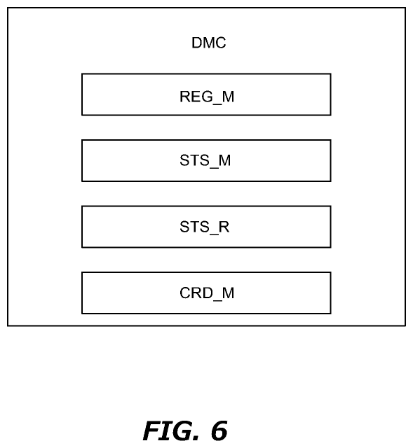

FIG. 6 illustrates a configuration example of the data DMC about the material center 50. In the example illustrated in FIG. 6, the data DMC includes registration data REG_M, stock situation data STS_M, operation situation data STS_R, and authentication data CRD_M. Note that the data DMC is generated or updated by the terminal 51 in the material center 50 illustrated in FIG. 2. The data DMC is generated and updated by a data processing device 52 included in the terminal 51. Master data on the data DMC is stored in a database 53. Copied data from the data DMC is transmitted to the management server 10 via a communication device 54.

The registration data REG_M includes: data about the place and the like of the material center 50; and data about the delivery robot 80, such as the number and specifications (maximum payload) of delivery robots 80 managed by the material center 50. The stock situation data STS_M is data indicating the types of materials included in the material center 50, and the situation of the stocks of the materials. The materials include disposables (single-use materials), and those to be collected after use by the user USR (rental materials). For the former, the types and the total number of new ones are included in the stock situation data STS_M. For the latter, the types and the total number of ones allowed to be rented are included in the stock situation data STS_M.

The operation situation data STS_R includes data indicating the operation situations of the delivery robots 80 managed by the material center 50 (e.g., the delivery service in execution, and delivery service standby). The operation situation data STS_R is generated based on current state report data DRB transmitted from each delivery robot 80 to the terminal 51.

Here, the current state report data DRB is described. The current state report data DRB includes not only data indicating the operation situations of the delivery robots 80 but also data indicating the current positions of the delivery robots 80. The current state report data DRB includes not only data indicating the inner states of the delivery robots 80 but also data indicating the external environments of the delivery robots 80. Examples of the inner state data and the external recognition data are the same as those in the example in the description of the current state report data DVH.

The authentication data CRD_M is data used for authenticating the terminal 51 when the terminal 51 transmits the data DMC to the management server 10. The authentication data CRD_M is, for example, an authentication code.

2-2. Recommendation Data

Returning to FIG. 2, the description of the example of the various data exchanged between the configuration elements of the management system 100 is continued. Recommendation data DRC is transmitted from the management server 10 to the user terminal 30. The recommendation data DRC is data (data on recommendations) on facilities that match the preference of the user USR and are available for the user USR in the near future. The recommendation data DRC is generated based on the hobby data TST and the use situation data STS_F, for example. In another example, the recommendation data DRC is generated based on the two types of data described above, and on data about a future schedule of the user USR. In the other example, the recommendation data DRC is generated so as to exclude dates or time slots reserved with other scheduled items of the user USR.

The recommendation data DRC is generated by the data processing device 13. The recommendation data DRC is generated all the time, for example. In another example, the recommendation data DRC is generated every time the data used to generate the recommendation data DRC is generated or updated. In still another example, the recommendation data DRC is generated at a certain predetermined time in a day. The recommendation data DRC is transmitted by the communication device 12. The recommendation data DRC is transmitted at a certain predetermined time in a day, for example. In another example, the recommendation data DRC is transmitted once a week. In still another example, the recommendation data DRC is transmitted at a predetermined date and time preliminarily designated by the user USR.

In one transmission of the recommendation data DRC, the time period of “near future” included in the recommendation data DRC is set according to the interval at which the recommendation data DRC is transmitted. For example, when the recommendation data DRC is transmitted every day, “near future” is the next day of the transmission day. When the recommendation data DRC is transmitted every week, “near future” is seven days starting from the next day of the transmission day. In a case where the user USR preliminarily designates the time period, “near future” is the designated time period.

2-3. Reservation Request Data DRQ

The user USR operates the user terminal 30, activates a predetermined application, and confirms the recommendation data DRC. The recommendation data DRC is displayed on the user terminal 30, as a list of the leisure facilities 20 that match the preference of the user USR, for example. When a leisure facility 20 possibly intended to be used is found in the recommendation data DRC, the user USR makes a reservation of the leisure facility 20. The reservation of the leisure facility 20 is made by inputting a leisure facility 20 that the user USR wishes to use (hereinafter, also called a “requested facility”), and an available time slot (or a combination of a date and an available time slot) of the requested facility.

After the reservation of the requested facility, the user USR may make accompanying reservations to the reservation. A reservation of the mobile 70 as transportation means to the requested facility is described as an example of the accompanying reservations. The reservation of the mobile 70 is made by inputting a pickup point that the user USR wishes, and a pickup time slot that the user USR wishes (or a combination of a date and a pickup time slot), for example.

The pickup point is input by selecting the home of the user USR, the parking lot 40 or the like, for example. The parking lot 40 to be selected is typically a parking lot that is close to the home of the user USR and has available mobiles 70. When the home of the user USR is selected as the pickup point, the user USR is transported from the home to the requested facility. When the parking lot 40 is selected as the pickup point, the user USR is transported from the standby space of the parking lot 40 to the requested facility. For the reservation of the mobile 70, items including the size and maximum payload of the mobile 70 may be additionally input.

Another example of accompanying reservations may be reservation of materials to be used in the requested facility. The materials are reserved by inputting the types and the number of materials to be used in the requested facility by the user USR (hereinafter, also called “requested materials”), and the delivery destinations of the requested materials, and delivery time slot of the requested materials, for example.

The delivery destination is input by selecting the home of the user USR, requested facility or the like, for example. When the home of the user USR is selected as the delivery destination, the requested materials are delivered to the home by the delivery robot 80. When the requested facility is selected as the delivery destination, the requested materials are delivered to the requested facility by the delivery robot 80.

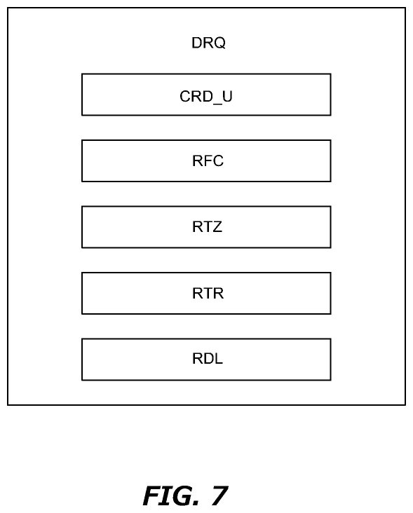

After the requested facility and the like are input, reservation request data DRQ is generated. FIG. 7 illustrates a configuration example of the reservation request data DRQ. In the example illustrated in FIG. 7, the reservation request data DRQ includes authentication data CRD_U, requested facility data RFC, request time slot data RTZ, transportation request data RTR, and delivery request data RDL. Note that the reservation request data DRQ is generated by the user terminal 30. The generated reservation request data DRQ is transmitted from the user terminal 30 to the management server 10.

The authentication data CRD_U is data on the user USR having made the input into the user terminal 30, and is data also included in the data DUS illustrated in FIG. 4. The requested facility data RFC is data for identifying the requested facility. The request time slot data RTZ is data for identifying the available time slot of the requested facility. The authentication data CRD_U, the requested facility data RFC, and the request time slot data RTZ are necessary configuration data in the reservation request data DRQ.

Meanwhile, the transportation request data RTR and the delivery request data RDL are included in the reservation request data DRQ when accompanying reservations are made. The transportation request data RTR includes data on the pickup point, and data on the pickup time slot. Data, such as on the size and the maximum payload of the mobile 70, may be added to the transportation request data RTR. The delivery request data RDL includes data on the types and number of requested materials, data on the delivery destination, and data on the delivery time slot.

2-4. Various Instructions Based on Reservation Request Data DRQ

When the reservation request data DRQ is received from the user terminal 30, various reservation request instructions are generated based on the reservation request data DRQ. The various reservation request instructions are generated by the data processing device 13. A facility reservation instruction CRS, a transportation arrangement instruction CTR, and a delivery arrangement instruction CDL are exemplified as the various reservation request instructions.

The facility reservation instruction CRS is transmitted from the management server 10 (communication device 12) to the leisure facility 20. Transmission of the facility reservation instruction CRS is destined for the leisure facility 20 identified by the requested facility data RFC. The facility reservation instruction CRS includes, for example, the authentication data CRD_U, and the request time slot data RTZ.

The transportation arrangement instruction CTR is transmitted from the management server 10 (communication device 12) to the parking lot 40. The transmission of the transportation arrangement instruction CTR is destined for the parking lot 40 selected by the data on the pickup point. The method of selecting the parking lot 40 is described later. The transportation arrangement instruction CTR includes, for example, the authentication data CRD_U, and the transportation request data RTR.

The delivery arrangement instruction CDL is transmitted from the management server 10 (communication device 12) to the material center 50. The transmission of the delivery arrangement instruction CDL is destined for the material center 50 selected by the data on the delivery destination. The method of selecting the material center 50 is described later. The delivery arrangement instruction CDL includes, for example, the authentication data CRD_U, and the delivery request data RDL.

After the transportation arrangement instruction CTR is transmitted from the management server 10 to the parking lot 40, a transportation execution instruction CVH is generated based on the transportation arrangement instruction CTR. The transportation execution instruction CVH is generated by the data processing device 42. The generated transportation execution instruction CVH is transmitted to the mobile 70 by the communication device 44. Transmission of the transportation execution instruction CVH is destined for an available mobile 70 included in the parking lot 40. The transportation execution instruction CVH includes the authentication data CRD_U, and the transportation request data RTR.

After the delivery arrangement instruction CDL is transmitted from the management server 10 to the material center 50, a delivery execution instruction CRB is generated based on the delivery arrangement instruction CDL. The delivery execution instruction CRB is generated by the data processing device 52. The generated delivery execution instruction CRB is transmitted to the delivery robot 80 by the communication device 54. The transmission of the delivery execution instruction CRB is destined for a delivery robot 80 capable of delivering the requested materials in the material center 50. The delivery execution instruction CRB includes the authentication data CRD_U, and the delivery request data RDL.

2-5. Various Responses Based on Various Reservation Request Instructions

After the facility reservation instruction CRS is transmitted from the management server 10 to the leisure facility 20, the requested facility is reserved according to the facility reservation instruction CRS. The requested facility is reserved by a data processing device 32. When the requested facility is reserved, the use situation data STS_F is updated. After the use situation data STS_F is updated, a reservation completion report RRS is transmitted from the leisure facility 20 to the management server 10. The reservation completion report RRS is data for reporting completion of reservation of the requested facility based on the facility reservation instruction CRS.

When the transportation arrangement instruction CTR is transmitted from the management server 10 to the parking lot 40, a mobile 70 to which the transportation execution instruction CVH is to be transmitted is selected, according to the transportation arrangement instruction CTR. The mobile 70 is selected by the data processing device 42. The method of selecting the mobile 70 is described later. After the mobile 70 is selected, the operation situation data STS_P is updated. After the operation situation data STS_P is updated, an arrangement completion report RVH is transmitted from the parking lot 40 to the management server 10. The arrangement completion report RVH is data for reporting completion of arrangement of the mobile 70 based on the transportation arrangement instruction CTR.

When the delivery arrangement instruction CDL is transmitted from the management server 10 to the material center 50, the requested materials are prepared according to the delivery arrangement instruction CDL. In addition, the delivery robot 80 to which the delivery execution instruction CRB is to be transmitted is selected. The delivery robot 80 is selected by the data processing device 52. The method of selecting the delivery robot 80 is described later. After the delivery robot 80 is selected, the stock situation data STS_M and the operation situation data STS_R are updated. After these data are updated, an arrangement completion report RRB is transmitted from the material center 50 to the management server 10. The arrangement completion report RRB is data for reporting completion of arrangement of the requested materials based on the delivery arrangement instruction CDL.

After the reservation completion report RRS is transmitted from the leisure facility 20 to the management server 10, a reservation confirmation report RUS is generated. The reservation confirmation report RUS is generated by the data processing device 13. The reservation confirmation report RUS includes data on the reserved leisure facility 20 (e.g., authentication data CRD_F), and data on the reserved time slot. The reservation confirmation report RUS is transmitted from the communication device 12 to the user terminal 30.

After the arrangement completion report RVH is transmitted from the parking lot 40 to the management server 10, data related to the arrangement completion report RVH is added to the reservation confirmation report RUS. The related data is added by the data processing device 13. The related data corresponds to the transportation request data RTR. The data on the pickup point, and the data on the pickup time slot are exemplified as data corresponding to the transportation request data RTR. The related data may include authentication data on the arranged mobile 70. The authentication data is used when the mobile 70 picks up the user USR.

After the arrangement completion report RRB is transmitted from the material center 50 to the management server 10, data related to the arrangement completion report RRB is added to the reservation confirmation report RUS. The related data is added by the data processing device 13. The related data corresponds to the delivery request data RDL. The data on the types and number of requested materials, data on the delivery destination, and the data on the delivery time slot are exemplified as data corresponding to the delivery request data RDL. The related data may include authentication data on the arranged delivery robot 80. The authentication data is used when the user USR unloads the requested materials from the delivery robot 80.

3. Example of Various Processing by Computer

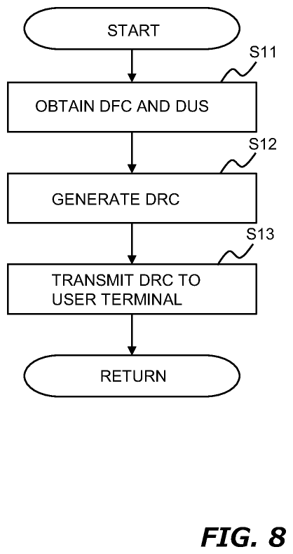

Next, referring to FIGS. 8 to 15, an example of various processing and various controls performed by configuration elements of the management system 100 illustrated in FIG. 1 is described.

3-1. Example of Processing by Management Server

FIG. 8 is a flowchart illustrating an example of processing performed by the management server 10 (data processing device 13). The routine illustrated in FIG. 8 is repeatedly executed at predetermined processing interval, for example.

First, according to the routine illustrated in FIG. 8, the data DFC and DUS are obtained from the database 11 (step S11). As described with reference to FIG. 3, the data DFC relates to the leisure facilities 20. As illustrated in FIG. 4, the data DUS relates to the user USR.

After the processing in step S11, the recommendation data DRC is generated (step S12). As already described, the recommendation data DRC is data on facilities that match the preference of the user USR and are available for the user USR in the near future. For example, the recommendation data DRC is generated based on, for example, the data DFC (use situation data STS_F) and the data DUS (hobby data TST) obtained by the processing in step S11.

After the processing in step S12, the recommendation data DRC is transmitted (step S13). The transmitted recommendation data DRC has been generated in the processing in step S12. The transmission destination of the recommendation data DRC is the user terminal 30. The user terminal 30 is identified based on the authentication data CRD_U included in the data DFC obtained in the processing in step S11.

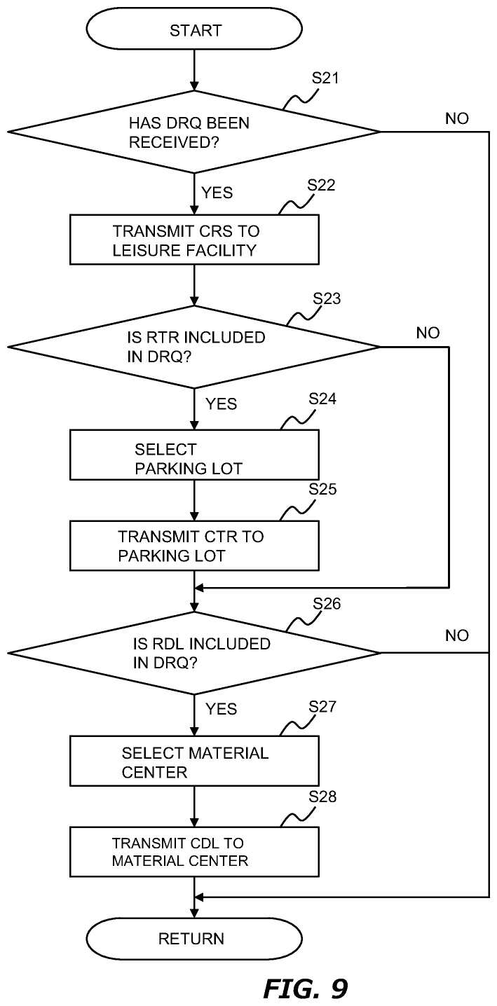

FIG. 9 is a flowchart illustrating another example of processing performed by the management server 10 (data processing device 13). The routine illustrated in FIG. 9 is repeatedly executed at predetermined processing interval, for example.

In the routine illustrated in FIG. 9, first, it is determined whether the reservation request data DRQ has been received or not (step S21). As already described, the reservation request data DRQ is generated by the user, having viewed the recommendation data DRC, inputting the requested facility and the like into the user terminal 30. If the determination result in step S21 is negative, the processing of the routine illustrated in FIG. 9 are finished.

If the determination result in step S21 is affirmative, the facility reservation instruction CRS is transmitted to the leisure facility 20 (step S22). The transmission destination of the facility reservation instruction CRS is the requested facility. The requested facility is identified based on the requested facility data RFC included in the reservation request data DRQ.

After the processing in step S22, it is determined whether the transportation request data RTR is included in the reservation request data DRQ or not (step S23). As already described, the transportation request data RTR is included in the reservation request data DRQ when accompanying reservations are made. If the determination result in step S23 is negative, the processing in step S26 is performed.

If the determination result in step S23 is affirmative, the parking lot 40 is selected (step S24). The parking lot 40 is selected based on data included in the transportation request data RTR (i.e., the data on the pickup point, and the data on the pickup time slot). In the selection of the parking lot 40, a parking lot 40 that is near to the pickup point and has an available mobile 70 is specifically identified.

The available mobile 70 is a mobile 70 having no scheduled transportation service from the start time of the pickup time slot to the start time of the available time slot of the requested facility. It is determined whether the available mobile 70 is included in the parking lot 40 or not based on the data DPK (operation situation data STS_P) stored in the database 11. When multiple parking lot 40 having available mobiles 70 are present, the parking lot 40 having the shortest distance to the pickup point is selected.

After the processing in step S24, the transportation arrangement instruction CTR is transmitted to the parking lot 40 (step S25). The transmission destination of the transportation arrangement instruction CTR is the parking lot 40 selected by the processing in step S24.

In the processing in step S26, it is determined whether the delivery request data RDL is included in the reservation request data DRQ or not. As already described, the delivery request data RDL is included in the reservation request data DRQ when accompanying reservations are made. If the determination result in step S26 is negative, the processing of the routine illustrated in FIG. 9 are finished.

If the determination result in step S26 is affirmative, the material center 50 is selected (step S27). The material center 50 is selected based on data included in the delivery request data RDL (i.e., the data on the types and number of requested materials, the data on the delivery destination, and the data on the delivery time slot). In the selection of the material center 50, the material center 50 that has stocks of requested materials, is near to the delivery destination, and has a delivery robot 80 capable of delivering the requested materials is specifically identified.

Presence or absence of stocks of requested materials is determined based on the data DMC (stock situation data STS_M) stored in the database 11. The delivery robot 80 capable of delivering the requested materials is a delivery robot 80 having no scheduled delivery service from the start time to the finish time of the delivery time slot. It is determined whether the material center 50 has a delivery robot 80 capable of delivering the requested materials or not based on the data DMC (operation situation data STS_R). When multiple material centers 50 having delivery robots 80 capable of delivering the requested materials are present, the material center 50 having the shortest distance to the delivery destination is selected.

After the processing in step S27, the delivery arrangement instruction CDL is transmitted to the material center 50 (step S28). The transmission destination of the delivery arrangement instruction CDL is the material center 50 selected by the processing in step S27.

3-2. Example of Processing in Leisure Facility

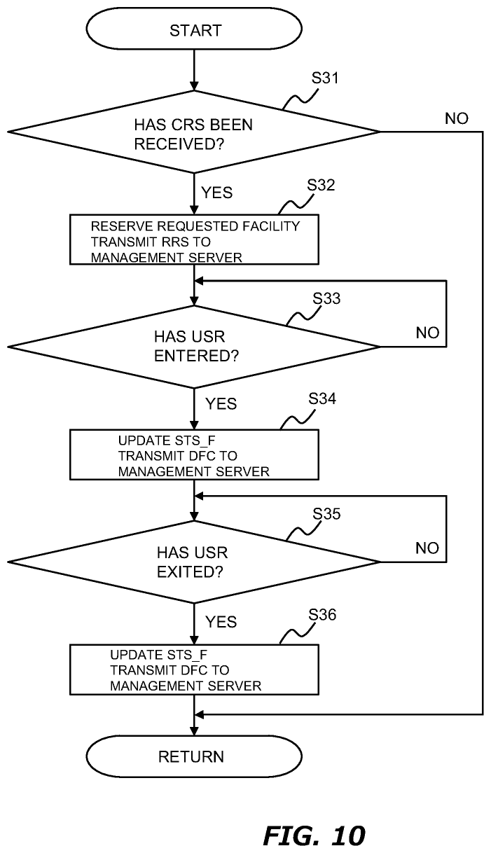

FIG. 10 is a flowchart illustrating an example of processing performed by the leisure facility 20 (data processing device 22). The routine illustrated in FIG. 10 is repeatedly executed at predetermined processing interval, for example.

In the routine illustrated in FIG. 10, first, it is determined whether the facility reservation instruction CRS has been received or not (step S31). As already described, when the reservation request data DRQ is received from the user terminal 30, the facility reservation instruction CRS is transmitted from the management server 10 to the requested facility. If the determination result in step S31 is negative, the processing of the routine illustrated in FIG. 10 are finished.

If the determination result in step S31 is affirmative, the requested facility is reserved (step S32). When the requested facility is reserved, the use situation data STS_F is updated. In the processing in step S32, after the use situation data STS_F is updated, the reservation completion report RRS is transmitted to the management server 10. When the use situation data STS_F is updated, the data DFC is also updated. Accordingly, in the processing in step S32, the reservation completion report RRS and the data DFC may be transmitted to the management server 10.

After the processing in step S32, it is determined whether the user USR has entered the requested facility or not (step S33). The entrance of the user USR is determined based on whether authentication has been performed between the requested facility and the user USR or not, for example. The processing in step S33 is repeatedly executed until an affirmative determination result is obtained.

If the determination result in step S33 is affirmative, the use situation data STS_F is updated (step S34). In the processing in step S34, after the use situation data STS_F is updated, data DFC is transmitted to the management server 10.

After the processing in step S34, it is determined whether the user USR has exited from the requested facility or not (step S35). The method of determining the exit of the user USR is similar to the method of determining the entrance of the user USR. The processing in step S35 is repeatedly executed until an affirmative determination result is obtained.

If the determination result in step S35 is affirmative, the use situation data STS_F is updated (step S36). The content of the processing in step S36 is the same as that of the processing in step S34.

3-3. Example of Processing in Parking Lot

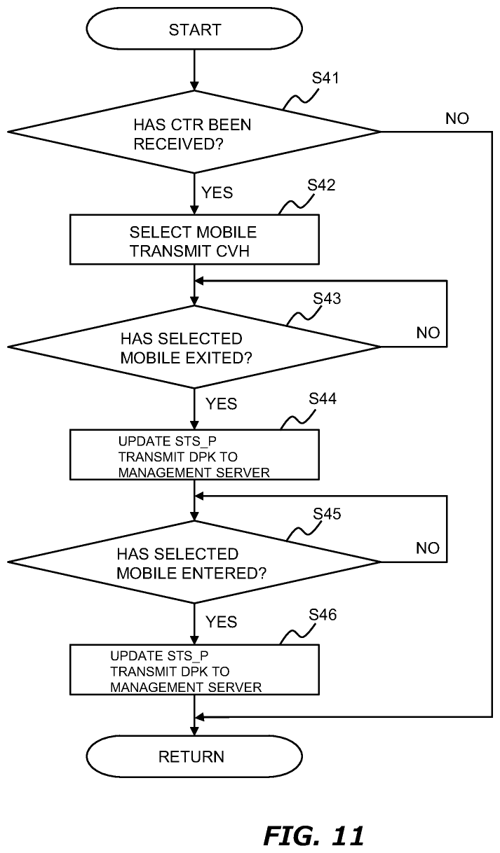

FIG. 11 is a flowchart illustrating an example of processing performed by the parking lot 40 (data processing device 42). The routine illustrated in FIG. 11 is repeatedly executed at predetermined processing interval, for example.

In the routine illustrated in FIG. 11, first, it is determined whether the transportation arrangement instruction CTR has been received or not (step S41). As already described, when transportation request data DTR is received from the user terminal 30, the transportation arrangement instruction CTR is transmitted from the management server 10 to the parking lot 40. The transmission destination of the transportation arrangement instruction CTR is the parking lot 40 selected by the processing in step S24 in FIG. 9. If the determination result in step S41 is negative, the processing of the routine illustrated in FIG. 11 are finished.

After the processing in step S41, the mobile 70 is selected (step S42). The mobile 70 selected in the processing in step S42 is one of the available mobiles 70. When data on the size and the maximum payload is included in the transportation arrangement instruction CTR, the mobiles 70 are narrowed down based on the data. In the processing in step S42, the transportation execution instruction CVH is transmitted to the selected mobile 70 (hereinafter, also called a “selected mobile”).

After the processing in step S42, it is determined whether the selected mobile has been unloaded from the parking lot 40 or not (step S43). As already described, the parking lot 40 manages the AVP for the mobile 70. The AVP (automated unloading) for the selected mobile is executed, and thus the selected mobile is moved from the parking space to the standby space. After the selected mobile reaches the standby space, it is determined that the selected mobile has been unloaded from the parking lot 40. The processing in step S43 is repeatedly executed until an affirmative determination result is obtained.

If the determination result in step S43 is affirmative, the operation situation data STS_P is updated (step S44). In the processing in step S44, after the operation situation data STS_P is updated, the data DPK is transmitted to the management server 10.

After the processing in step S44, it is determined whether the selected mobile has been loaded into the parking lot 40 or not (step S45). After the transportation service is executed by the selected mobile, the selected mobile returns to the standby space of the parking lot 40. After the selected mobile reaches the standby space, AVP (automatic loading) for the selected mobile is performed. Thus, the selected mobile moves from the standby space to the parking space. After the selected mobile reaches the parking space, it is determined that the selected mobile has been loaded from the parking lot 40. The processing in step S45 is repeatedly executed until an affirmative determination result is obtained.

If the determination result in step S45 is affirmative, the operation situation data STS_P is updated (step S46). The content of the processing in step S46 is the same as that of the processing in step S44.

3-4. Example of Processing in Selected Mobile

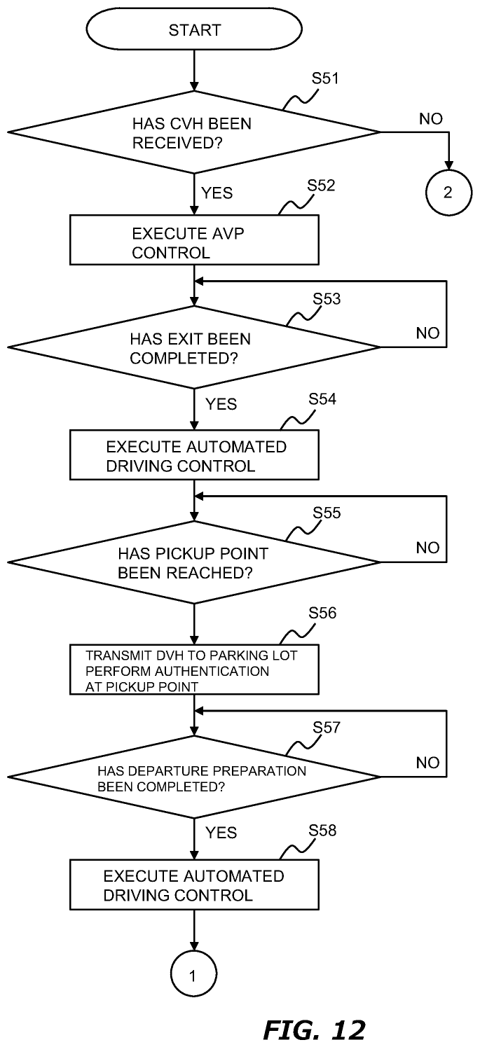

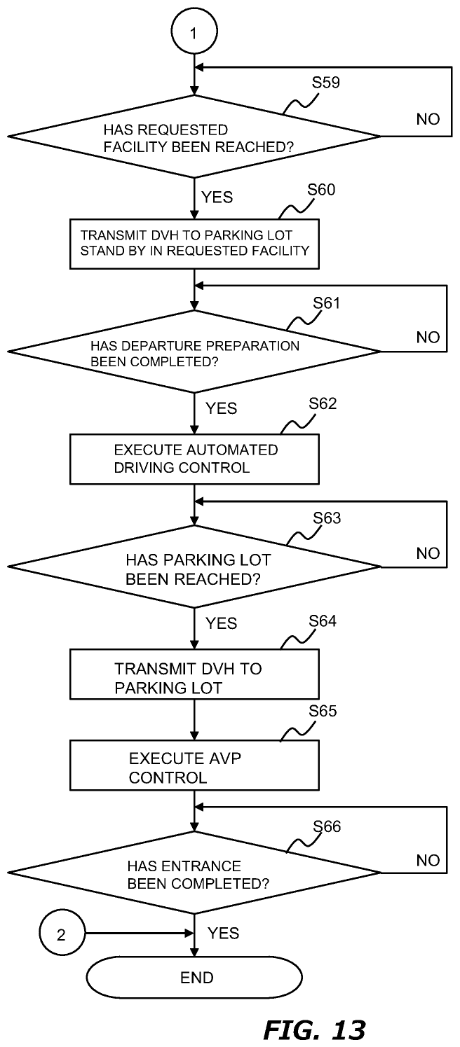

FIGS. 12 and 13 are flowcharts illustrating an example of processing performed by the selected mobile (control device). The routine illustrated in FIGS. 12 and 13 is repeatedly executed at predetermined processing interval, for example.

In the routine illustrated in FIGS. 12 and 13, first, it is determined whether the transportation execution instruction CVH has been received or not (step S51). As already described, when the transportation arrangement instruction CTR is received from the management server 10, the transportation execution instruction CVH is transmitted from the parking lot 40 to the selected mobile. If the determination result in step S51 is negative, the processing of the routine illustrated in FIGS. 12 and 13 are finished.

If the determination result in step S51 is affirmative, AVP control (automatic unloading control) is executed (step S52). According to the automatic unloading control, drive, braking and steering of the selected mobile are controlled such that this object can automatically be driven on a route from the parking space to the standby space of the parking lot 40 while the selected mobile and the parking lot 40 are communicating with each other.

After the processing in step S52, it is determined whether unloading of the selected mobile has been completed or not (step S53). After the selected mobile reaches the standby space, it is determined that unloading of the selected mobile has been completed. The processing in step S53 is repeatedly executed until an affirmative determination result is obtained.

If the determination result in step S53 is affirmative, automated driving control is performed (step S54). In the processing in step S54, the drive, braking and steering of the selected mobile are controlled so as to achieve automated driving on the route from the standby space to the pickup point. During execution of the automated driving control, the current state report data DVH is appropriately transmitted.

After the processing in step S54, it is determined whether the selected mobile has reached the pickup point or not (step S55). The determination of whether the selected mobile has reached the pickup point or not is performed based on the current position of the selected mobile. The processing in step S55 is repeatedly executed until an affirmative determination result is obtained.

If the determination result in step S55 is affirmative, the current state report data DVH is transmitted to the parking lot 40 (step S56). The current state report data DVH transmitted in the processing in step S56 is data indicating that the selected mobile has reached the pickup point. When the processing in step S56 is performed, the parking lot 40 may update the operation situation data STS_P and notify the management server 10 of the arrival of the selected mobile. In this case, the management server 10 may notify the user terminal 30 of the arrival of the selected mobile. When the user terminal 30 is notified, the current state report data DVH may be transmitted from the selected mobile to the management server 10.

The selected mobile having reached the pickup point waits for arrival of the user USR at the pickup point. In the processing in step S56, the user USR is authenticated at the pickup point. If the user USR has reached the pickup point, authentication is performed between the user USR and the selected mobile using near field communication or the like. After the authentication is completed, the selected mobile releases the locks of doors. This allows the user to get in the selected mobile.

After the processing in step S56, it is determined whether departure preparation has been completed or not (step S57). The determination of whether the departure preparation has been completed or not is made according to whether a predetermined condition is satisfied or not, for example. Examples of the predetermined condition include, for example, recognition of the user USR having gotten in the selected mobile, and confirmation of safety around the selected mobile. The processing in step S57 is repeatedly executed until an affirmative determination result is obtained.

If the determination result in step S57 is affirmative, automated driving control is performed (step S58). In the processing in step S58, the drive, braking and steering of the selected mobile are controlled so as to achieve automated driving on the route from the pickup point to the requested facility. During execution of the automated driving control, the current state report data DVH is appropriately transmitted.

After the processing in step S58, it is determined whether the selected mobile has reached the requested facility or not (step S59). The determination of whether the selected mobile has reached the requested facility or not is made based on the current position of the selected mobile. The processing in step S59 is repeatedly executed until an affirmative determination result is obtained.

If the determination result in step S59 is affirmative, the current state report data DVH is transmitted to the parking lot 40 (step S60). The current state report data DVH transmitted in the processing in step S60 is data indicating that the selected mobile has reached the requested facility. When the processing in step S60 is performed, the parking lot 40 may update the operation situation data STS_P and notifies the management server 10 of the arrival of the selected mobile.

The selected mobile having reached the requested facility drops off the user USR in any space (e.g., the space of a porch) in the requested facility, and stops in any space (e.g., a parking space). That is, in the processing in step S60, this object waits for return of the user USR in the requested facility. Note that without waiting for the return of the user USR, a process for returning to the parking lot 40 may be performed. Alternatively, in the middle of returning to the parking lot 40, a process for picking up another user USR other than the user USR may be performed.

After the processing in step S60, it is determined whether departure preparation has been completed or not (step S61). The processing in step S61 is a process for picking up the user USR having been transported to the requested facility, in any space (e.g., the space of a porch) in the requested facility. The determination of whether the departure preparation has been completed or not is made according to whether a predetermined condition is satisfied or not, for example. The examples of the predetermined condition may be those exemplified in the description of step S57.

If the determination result in step S61 is affirmative, automated driving control is performed (step S62). In the processing in step S62, the drive, braking and steering of the selected mobile are controlled so as to achieve automated driving on the route from the pickup point in the requested facility to the standby space of the parking lot 40. During execution of the automated driving control, the current state report data DVH is appropriately transmitted.

After the processing in step S62, it is determined whether the selected mobile has reached the parking lot 40 or not (step S63). The determination of whether the selected mobile has reached the parking lot 40 or not is made based on the current position of the selected mobile. The processing in step S63 is repeatedly executed until an affirmative determination result is obtained.

If the determination result in step S63 is affirmative, the current state report data DVH is transmitted to the parking lot 40 (step S64). The current state report data DVH transmitted in the processing in step S64 is data indicating that the selected mobile has reached the parking lot 40. When the processing in step S64 is performed, the parking lot 40 may transmit various instructions to the selected mobile to prepare for AVP (automatic loading) for the selected mobile.

After the processing in step S64, AVP control (automatic loading control) is executed (step S65). According to the automatic loading control, drive, braking and steering of the selected mobile are controlled such that this object can automatically be driven on a route from the standby space to the parking space of the parking lot 40 while the selected mobile and the parking lot 40 are communicating with each other.

After the processing in step S65, it is determined whether the selected mobile has been loaded or not (step S66). After the selected mobile reaches the parking space, it is determined that loading of the selected mobile has been completed. The processing in step S66 is repeatedly executed until an affirmative determination result is obtained.

3-5. Example of Processing in Material Center

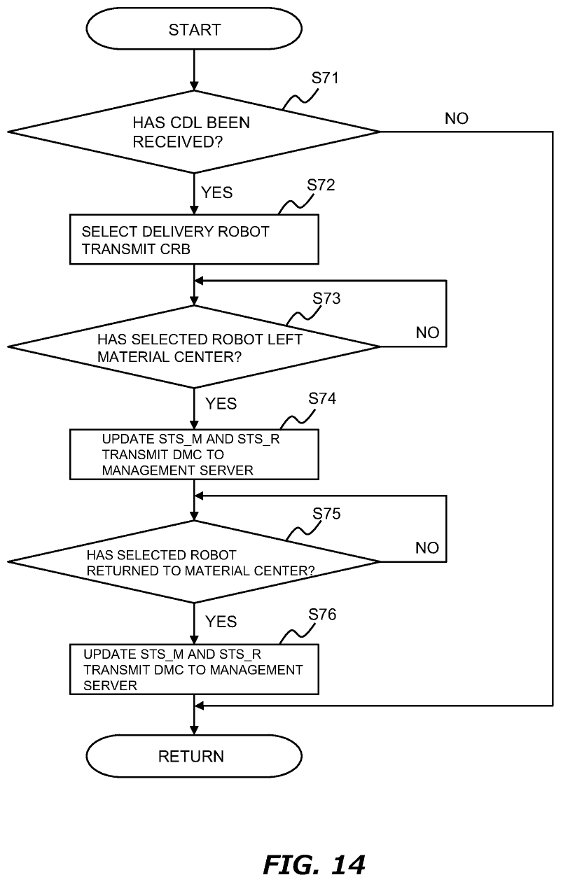

FIG. 14 is a flowchart illustrating an example of processing performed by the material center 50 (data processing device 52). The routine illustrated in FIG. 14 is repeatedly executed at predetermined processing interval, for example.

In the routine illustrated in FIG. 14, first, it is determined whether the delivery arrangement instruction CDL has been received or not (step S71). As already described, when a delivery request data DDL is received from the user terminal 30, the delivery arrangement instruction CDL is transmitted from the management server 10 to the material center 50. The transmission destination of the delivery arrangement instruction CDL is the material center 50 selected by the processing in step S27 in FIG. 9. If the determination result in step S71 is negative, the processing of the routine illustrated in FIG. 14 are finished.

After the processing in step S71, the delivery robot 80 is selected (step S72). The delivery robot 80 selected in the processing in step S72 is one of delivery robots 80 capable of delivering the requested materials. In the processing in step S72, the delivery execution instruction CRB is transmitted to the selected delivery robot 80 (hereinafter, also called a “selected robot”).

After the processing in step S72, it is determined whether the selected robot has left the material center 50 or not (step S73). The determination of whether the selected robot has left the material center 50 or not is made based on the current position of the selected robot. The processing in step S73 is repeatedly executed until an affirmative determination result is obtained.

If the determination result in step S73 is affirmative, the stock situation data STS_M and the operation situation data STS_R are updated (step S74). After these data are updated, in the processing in step S74 the data DMC is transmitted to the management server 10.

After the processing in step S74, it is determined whether the selected robot has returned to the material center 50 or not (step S75). After the delivery service is executed by the selected robot, the selected robot returns to the material center 50. The determination of whether the selected robot has reached the material center 50 or not is made based on the current position of the selected robot. The processing in step S75 is repeatedly executed until an affirmative determination result is obtained.

If the determination result in step S75 is affirmative, the stock situation data STS_M and the operation situation data STS_R are updated (step S76). The content of the processing in step S76 is the same as that of the processing in step S74.

3-6. Example of Processing in Selected Robot

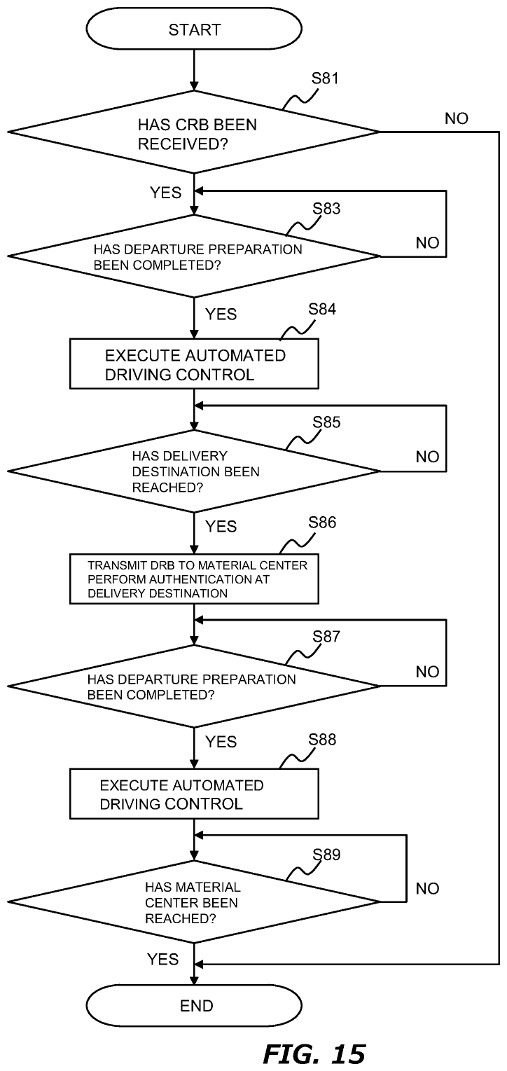

FIG. 15 is a flowchart illustrating an example of processing performed by the selected robot (control device). The routine illustrated in FIG. 15 is repeatedly executed at predetermined processing interval, for example.

In the routine illustrated in FIG. 15, first, it is determined whether the delivery execution instruction CRB has been received or not (step S81). As already described, when the delivery arrangement instruction CDL is received from the management server 10, the delivery execution instruction CRB is transmitted from the material center 50 to the selected robot. If the determination result in step S81 is negative, the processing of the routine illustrated in FIG. 15 are finished.

If the determination result in step S81 is affirmative, it is determined whether departure preparation has finished or not (step S83). The determination of whether the departure preparation has been completed or not is made according to whether a predetermined condition is satisfied or not, for example. Examples of the predetermined condition may be, for example, completion of loading of the requested materials into the selected robot. The processing in step S83 is repeatedly executed until an affirmative determination result is obtained.

If the determination result in step S83 is affirmative, automated driving control is performed (step S84). In the processing in step S84, the drive, braking and steering of the selected robot are controlled so as to achieve automated driving on the route from the material center 50 to the delivery destination. During execution of the automated driving control, the current state report data DRB is appropriately transmitted.

After the processing in step S84, it is determined whether the selected robot has reached the delivery destination or not (step S85). The determination of whether the selected robot has reached the delivery destination or not is made based on the current position of the selected robot. The processing in step S85 is repeatedly executed until an affirmative determination result is obtained.

If the determination result in step S85 is affirmative, the current state report data DRB is transmitted to the material center 50 (step S86). The current state report data DRB transmitted in the processing in step S86 is data indicating that the selected robot has reached the delivery destination. When the processing in step S86 is performed, the material center 50 may update the operation situation data STS_R and notify the management server 10 of the arrival of the selected robot. In this case, the management server 10 may notify the user terminal 30 of the arrival of the selected robot. When the user terminal 30 is notified, the current state report data DRB may be transmitted from the selected robot to the management server 10.

The selected robot having reached the delivery destination waits for arrival of the user USR at the delivery destination. In the processing in step S86, the user USR is authenticated at the delivery destination. If the user USR has reached the delivery destination, authentication is performed between the user USR and the selected robot using near field communication or the like. After the authentication is completed, the selected robot releases the locks of doors. This allows the requested materials to be taken out from the selected robot.

After the processing in step S86, it is determined whether departure preparation has been completed or not (step S87). The determination of whether the departure preparation has been completed or not is made according to whether a predetermined condition is satisfied or not, for example. Examples of the predetermined condition may be, for example, completion of taking out the requested materials from the selected robot. The processing in step S87 is repeatedly executed until an affirmative determination result is obtained.

Note that in the example illustrated in FIG. 15, after completion of taking out the requested materials, a process for returning to the material center 50 is performed. Note that if the requested materials include rental materials, a process for waiting for return of the user USR may be performed. Alternatively, in the middle of returning to the material center 50, a process for collecting rental materials for another user USR other than the user USR may be performed.

If the determination result in step S87 is affirmative, automated driving control is performed (step S88). In the processing in step S88, the drive, braking and steering of the selected robot are controlled so as to achieve automated driving on the route from the delivery destination to the material center 50. During execution of the automated driving control, the current state report data DRB is appropriately transmitted.

After the processing in step S88, it is determined whether the selected robot has reached the material center 50 or not (step S89). The determination of whether the selected robot has reached the material center 50 or not is made based on the current position of the selected robot. The processing in step S89 is repeatedly executed until an affirmative determination result is obtained.

4. Effects

The management system according to the embodiment allows the recommendation data DRC generated by the management server 10 to be transmitted to the user terminal 30. The recommendation data DRC is generated based on the hobby data TST and the use situation data STS_F on the user USR. Accordingly, the user USR viewing the recommendation data DRC is expected to use the leisure facility 20 matching their own preference. That is, the management system according to the embodiment can provide information useful for the user USR excursively wishing to use a leisure facility 20 belonging to a certain category and facilitate use of the leisure facility 20.

When the reservation request data DRQ is transmitted from the user terminal 30 to the management server 10, the management system according to the embodiment can automatically reserve the requested facility. When the reservation request data DRQ includes the transportation request data RTR, transportation means to the requested facility is automatically arranged. When the reservation request data DRQ includes the delivery request data RDL, the requested materials are automatically delivered to the delivery destination. Consequently, preparation, arrangement and the like of the transportation means and the materials are prevented from serving as an impediment against use of the leisure facility 20. This leads to further enhancement of use of the leisure facility 20.

What is claimed is:

1. A facility use management system to manage use of various facilities by a user, comprising:
a management server including a data processing device and a storage device in which various data is stored; and
a user terminal operated by the user and configured to be communicate with the management server,
wherein the various data includes registration data on the user, hobby data on the user, registration data on the various facilities, and use situation data on the various facilities,
wherein the data processing device of the management server is configured to:
generates, based on the various data, recommendation data including data on facilities that match a preference of the user and are available to the user;
transmits the recommendation data to the user terminal;
determines whether reservation request data is received from the user terminal or not after transmission of the recommendation data,
wherein the reservation request data includes data on a requested facility wished by the user, and data on an available time slot of the requested facility; and
when it is determined that the reservation request data is received from the user terminal, make a reservation of the requested facility covering the available time slot, based on the reservation request data.

2. The facility use management system according to claim 1, further comprising:
a parking lot including a data processing device and a communication device configured to communicate with the management server; and
a plurality of mobiles, each of which including a communication device configured to communicate with the management server and the parking lot, a drive device, and a control device configured to control the drive device,
wherein, upon receipt of the reservation request data from the user terminal, the data processing device of the management server determine whether the reservation request data includes transportation request data or not,
wherein the transportation request data includes data on a pickup point wished by the user, and a pickup time slot wished by the user,
wherein the data processing device of the management server is configured to:
when it is determined that the reservation request data includes the transportation request data, generate a transportation arrangement instruction for providing the user with transportation from the pickup point to the requested facility, based on the transportation request data; and
transmit the transportation arrangement instruction to the parking lot,
wherein the data processing device of the parking lot is configured to:
upon receipt of the transportation arrangement instruction, select a mobile for transportation of the user from among the mobiles, based on the transportation arrangement instruction; and
transmit a transportation execution instruction to the selected mobile,
wherein the control device of the selected mobile is configured to perform, upon receipt of the transportation execution instruction, automated driving control from the parking lot to the pickup point and automated driving control from the pickup point to the requested facility, based on the transportation execution instruction.

3. The facility use management system according to claim 1, further comprising:
a material center including a data processing device and a communication device configured to communicate with the management server; and
a plurality of delivery robots, each of which including a communication device configured to communicate with the management server and the material center, a drive device, and a control device configured to control the drive device,
wherein the data processing device of the management server is configured to determine, upon receipt of the reservation request data from the user terminal whether the reservation request data includes delivery request data or not,
wherein the delivery request data includes data on a requested material wished by the user, data on a delivery destination of the requested material, and data on a delivery time slot for the requested material,
wherein the data processing device of the management server is configured to:
when it is determined that the reservation request data includes the delivery request data, generate a delivery arrangement instruction for delivering the requested material from the material center to the delivery destination, based on the delivery request data; and
transmit the delivery arrangement instruction to the material center,
wherein the data processing device of the material center is configured to:
upon receipt of the delivery arrangement instruction, select a delivery robot for delivering the requested material, from among the delivery robots, based on the delivery arrangement instruction; and
transmit a delivery execution instruction to the selected delivery robot,
wherein the control device of the selected delivery robot is configured to perform, upon receipt of the delivery execution instruction, automated driving control from the material center to the delivery destination, based on the delivery execution instruction.

4. A facility use management method to manages use of various facilities by a user through a management server, the method comprising the steps of:
generating recommendation data including data on a facility that matches a preference of the user and is available for the user, based on various data stored in a storage device, the various data including registration data on the user, hobby data on the user, registration data on the various facilities, and use situation data on the various facilities;
transmitting the recommendation data to the user terminal;
determining whether reservation request data is received from the user terminal or not after transmission of the recommendation data, the reservation request data including data on a requested facility wished by the user, and an available time slot of the requested facility; and
making a reservation of the requested facility covering the available time slot, based on the reservation request data, when it is determined that the reservation request data is from the user terminal.
